(19) United States
(12) Patent Application Publication
(10) Pub. No.: US 2007/0226037 A1
(43) Pub. Date: Sep. 27, 2007

(54) Modeling of opportunity data

(76) Inventors: Shailendra Garg, Sunnyvale, CA (US); Gurkan Salk, Istanbul (TR); Ramaswamy Sundararajan, Cupertino, CA (US); Maria Theresa Barnes Leon, Fremont, CA (US)

Correspondence Address: CAMPBELL STEPHENSON LLP, 11401 CENTURY OAKS TERRACE, BLDG. H, SUITE 250, AUSTIN, TX, 78758, US

(21) Appl. No.: 10/750,046

(22) Filed: Dec. 30, 2003

Related U.S. Application Data
(60) Provisional application No. 60/457,795, filed on Mar. 25, 2003.

(51) Int. Cl. G06Q 10/00; G07G 1/00

(52) U.S. Cl. 705/10; 705/1

(57) ABSTRACT

An opportunity class is defined that represents an opportunity and identifies relationships of the opportunity with various entities related to the opportunity.

### FIELD OF THE INVENTION

This invention relates generally to data modeling, and more particularly to modeling of opportunity data.

### COPYRIGHT NOTICE/PERMISSION

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright © 2001, Siebel Systems, Inc., All Rights Reserved.

### BACKGROUND OF THE INVENTION

Partner relationship management (PRM) is a business strategy for improving communication between companies and their partners. Web-based PRM software applications enable companies to customize and streamline administrative tasks by making shipping schedules available to all the partners over the Internet. However, no software product currently exists that allows partners to share data on potential business opportunities or leads. As a result, a company is unable to send leads to its partners, receive the partners' input on leads, view the status of leads managed by partners, or communicate any other data related to potential business opportunities to the partners. This creates difficulties in collaboration between the company and its partners and impedes successful development of business opportunities.

### SUMMARY OF THE INVENTION

The present invention relates to various aspects for modeling opportunity data.

According to one aspect of the present invention, an opportunity class is defined that represents an opportunity and identifies relationships of an opportunity with various entities related to the opportunity.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is a block diagram illustrating the interconnection between various business systems and a universal business application network, according to one embodiment of the present invention.

FIG. 2 is a block diagram illustrating the overall architecture of a universal business application network, according to one embodiment of the present invention.

FIG. 3 is a flow diagram of one embodiment of a process for facilitating the sharing of opportunity data between two applications.

FIG. 4 is a flow diagram of one embodiment of a process for adding custom data to an opportunity class.

FIGS. 5-14 illustrate one embodiment of a common data model representing an opportunity.

FIG. 15 is a block diagram of an exemplary computer system that may be used to perform one or more of the operations described herein.

### DETAILED DESCRIPTION OF THE INVENTION

In the following description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

A data model that provides a common data structure to represent an opportunity and allows for customization of the data model in a manner that facilitates upgrading of the data model is described. An opportunity refers to a possibility of making profit by proceeding with a certain business proposal, a specific business deal, or a potential business deal also known as a lead. Opportunity data may be used by various divisions within a company and/or multiple companies (e.g., a manufacturer, the manufacturer's partners such as resellers, third parties such as distributors, etc.).

In one embodiment, the opportunity data model defines relationships of an opportunity with various entities related to the opportunity. These entities may include, for example, related accounts (customers associated with the opportunity), related contacts (any party related to the opportunity), a parent opportunity (an opportunity that triggered the current opportunity), related sales employees and consultants, activities associated with the opportunity, a source organization (an organization that received information about the opportunity), a destination partner (an organization that manages the opportunity), and revenue information associated with the opportunity (e.g., expected revenue, realized revenue, etc.).

The data model models the relationships as attributes associated with an opportunity. In one embodiment, the opportunity data model is specified using a schema language such as XML Schema.

Based on the relationships defined by the opportunity data model, a revenue opportunity may be reported by account, product line, product, opportunity, service request, opportunity planner, or organization.

In one embodiment, the data model defines a hierarchy of the data elements for describing an opportunity. The data model may define data elements that are complex. A complex data element is a data element that comprises data sub-elements. For example, an address data element may be a complex data element that includes street, city, and state data sub-elements. The data model may specify custom data elements at various places within the hierarchy of data elements. A custom data element is of a custom data element type. The custom data element type initially defines no data elements. The data model can be customized by defining custom data elements that are specific to different applications or systems. Because the custom data elements are defined at various places within the hierarchy, the customizations of the data model can be associated with related data elements within the hierarchy.

Thus, the opportunity data model provides a common data structure for interfacing opportunity data of various divisions within an organization and/or opportunity data of an organization and collaborating third parties, while allowing for simplified customization of this data structure by individual companies in accordance with their needs. Hence, the opportunity data model allows companies to maintain, support and upgrade only a single data model and facilitates efficient data transformations and mappings.

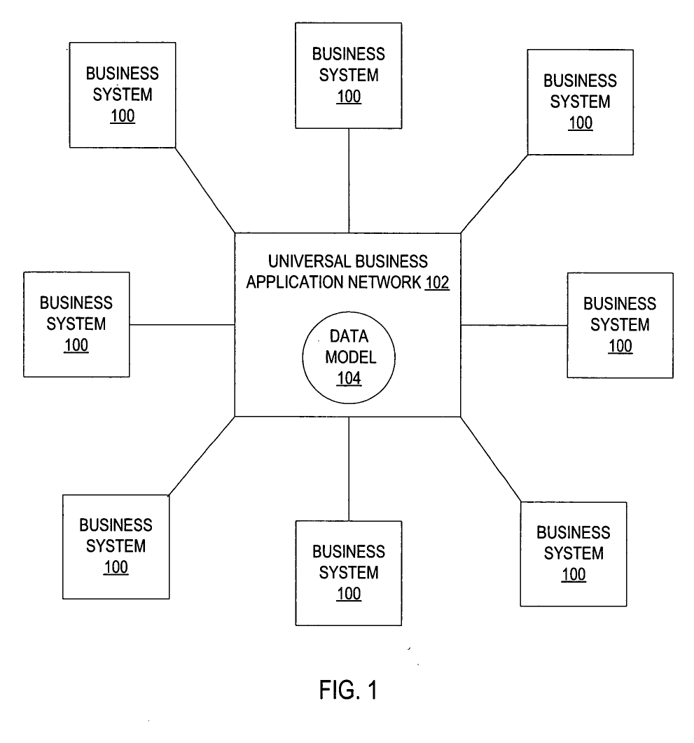

FIG. 1 is a block diagram illustrating the interconnection between various business systems 100 (business systems utilizing opportunity related data) and a universal business application network 102, according to one embodiment of the present invention. The universal business application network 100 serves as an integration hub for the business systems 100. The architecture of the universal business application network 102 allows new applications (e.g., customer relationship management (CRM) applications partner relationship management (PRM) applications) that access legacy business systems to be developed with minimum customization. The legacy business systems can be provided by a single business organization or by different business organizations. The universal business application network 102 allows the CRM and PRM applications to exchange information using an opportunity data model 104.

In one embodiment, the opportunity data model 104 defines a hierarchical data structure representing an opportunity. This hierarchical data structure includes data elements that are common to all business systems 100. In addition, the hierarchical data structure includes data custom data elements at various levels of the hierarchy to define data fields that are specific to each business system 100, thus providing for easy customization of the opportunity data model 104.

In one embodiment, the universal business application network 102 uses the XML and Web services standards.

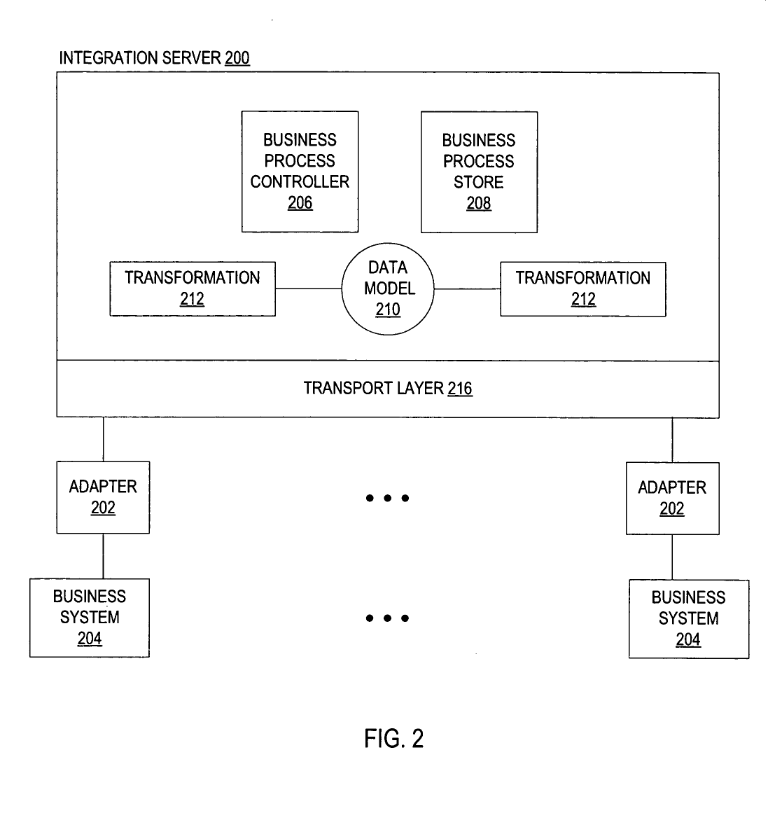

FIG. 2 is a block diagram illustrating the overall architecture of a universal business application network in one embodiment. The hub of the universal business application network is an integration server 200 that connects to the various business systems 204 (e.g., business systems utilizing opportunity related data) via adapters 202. The integration server 200 includes a transport layer 216, a data model 210, a transformation store 214, a business process controller 206, and a business process store 208.

The transport layer 216 is a mechanism through which business information is exchanged between the business systems 204 and the business integration server 200. Each business system 204 may have an adapter 202 that is appropriate to the protocol of the transport layer. For example, the transport mechanism may use communications protocols such as TCP/IP. The transport layer 216 may provide a messaging service for queuing, for guaranteeing delivery of messages, and for handling both synchronous and asynchronous messaging. The adapters 202 relay events from the business systems 204 to the integration server 200 and can import configurations of the business systems 204 into the integration server 200. In addition, the universal business application network may include encryption and authentication mechanisms to ensure the security and integrity of the information. For example, authentication will help ensure that a business process is accessing the intended business system, rather than an impostor business system.

The integration server 200 stores the representation of a data model 210 (e.g., in an XML schema file) that contains the definition of an opportunity class. The opportunity class represents an opportunity and defines relationships of the opportunity with various related entities.

The transformation store 212 contains a model data definition tool (e.g., an XML schema definition tool) to create a definition of the data model 210 (e.g., in an XML schema file) and to customize the data model 210 when requested by adding custom data fields to the data model 210. The transformation store 212 also contains transformations for transforming information received from the business systems 204 to the format used by the data model 210, and vice versa. The transformations may be specified as a computer program, an XML Stylesheet Language Transform (XSLT), etc.

The business process store 208 contains the business processes that have been defined. A business process may be specified as a script, a process flow, an executable program, etc. In one embodiment, the business processes are defined using the Web Services Flow Language (OOWSFL). The business processes orchestrate a sequence of steps across multiple applications provided by the business systems 204 to achieve a business objective.

The business process controller 206 coordinates the execution of the business processes. The business process controller 206 may instantiate the opportunity class and invoke functions of the resulting object in accordance with the various business processes. The business process controller 206 may also initiate the execution of business processes based on predefined conditions and events. For example, the business process controller 206 may launch a certain business process each time an alert is received. Although not shown, the business integration network may provide a standard library of business routines that may be invoked by the business processes. The integration server 200 may also include various tools to facilitate the development of business processes. These tools may aid in the development of transformations, the defining of classes, and the writing of process flows.

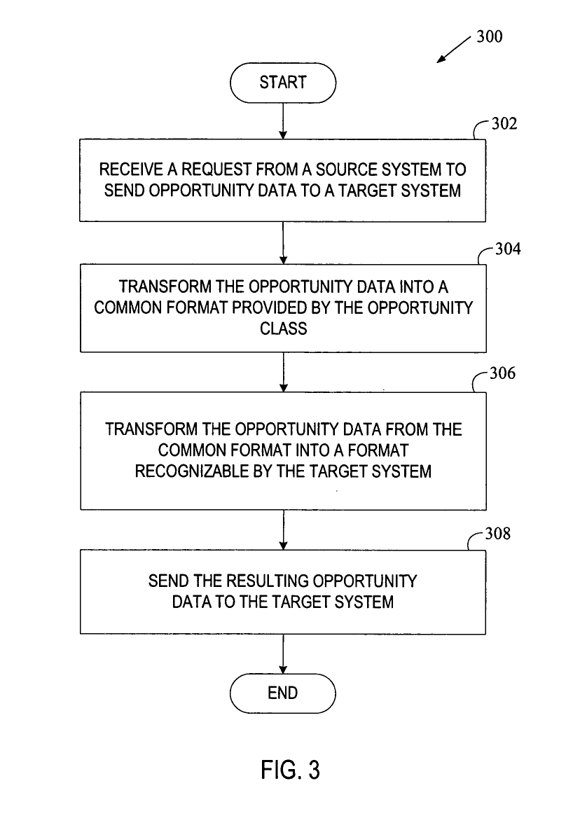

FIG. 3 is a flow diagram of one embodiment of a process 300 for facilitating the sharing of opportunity data between two insurance applications. The process may be performed by processing logic that may comprise hardware (e.g., circuitry, dedicated logic, etc.), software (such as run on a general purpose computer system or a dedicated machine), or a combination of both. Processing logic may reside on an integration server such as the integration server 200 of FIG. 2.

Referring to FIG. 3, process 300 begins with processing logic receiving a request from a source system to send opportunity data to a target system (processing block 302). For example, opportunity data may pertain to a lead created by a manufacturer, a source system may be a CRM or PRM application used by the manufacturer, and a target system may be a CRM or PRM application used by the manufacturer's partner (e.g., a reseller). In another example, opportunity data may pertain to an opportunity created by a partner (e.g., a reseller) or a third party (e.g., a distributor), a source system may be a CRM or PRM application used by the partner or third party, and a target system may be a CRM or PRM application used by a manufacturer.

Next, processing logic transforms the opportunity data into a common format provided by the opportunity class (processing block 304). The opportunity class defines relationships of an opportunity with various entities related to the opportunity. These entities may include, for example, related accounts (customers associated with the opportunity), related contacts (any party related to the opportunity), a parent opportunity (an opportunity that triggered the current opportunity), related sales employees and consultants, activities associated with the opportunity, a source organization (an organization that received information about the opportunity), a destination partner (an organization that manages the opportunity), and revenue information associated with the opportunity (e.g., expected revenue, realized revenue, etc.).

Further, processing logic transforms the opportunity data from the common format into a format recognizable by the target system (processing block 306) and sends the resulting opportunity data to the target system (processing block 308).

Thus, according to the process 300, the sharing of opportunity data between two systems does not require data mapping between the data format of the source application and the data format of the target application. Instead, the mapping is performed between each system and the common data model. Furthermore, the process 300 allows various divisions and/or organizations to share the opportunity data in a manner that allows access to up-to-date opportunity information by all participating parties, thus facilitating collaboration between the participating parties in the development of business opportunities.

As discussed above, in one embodiment, each class of the opportunity data model can be customized for a specific business system or application.

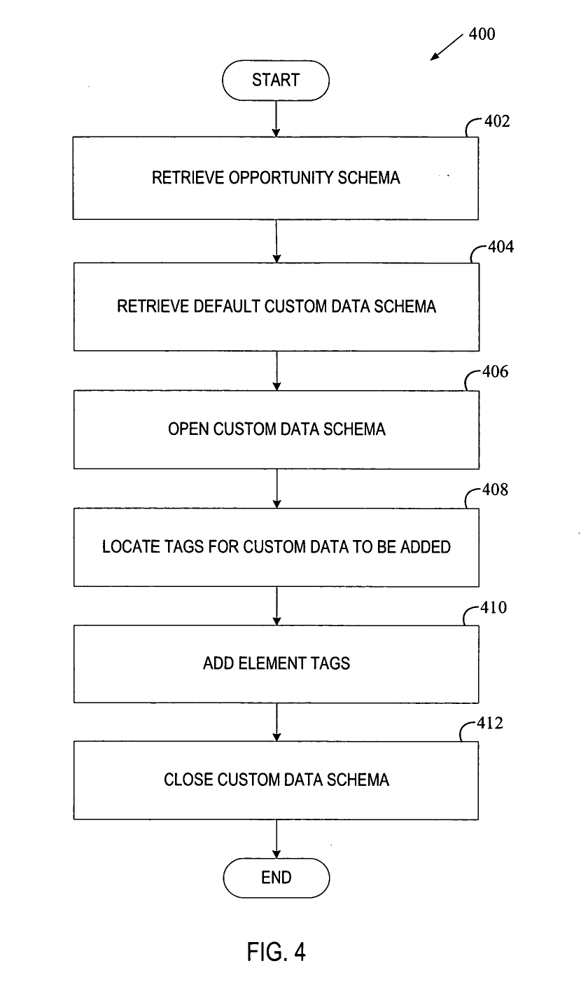

FIG. 4 is a flow diagram of one embodiment of a process for adding custom data to opportunity class. The process may be performed by processing logic that may comprise hardware (e.g., circuitry, dedicated logic, etc.), software (such as run on a general purpose computer system or a dedicated machine), or a combination of both. Processing logic may reside on an integration server such as the integration server 200 of FIG. 2.

At processing block 402, processing logic retrieves a data definition schema for the opportunity class. The schema may be an XML schema file that include a custom data element of a type that is defined in another file.

At processing block 404, processing logic retrieves the custom data schema for the types of custom data. The schema may be stored in an XML schema file that contains the definition for each type of custom data.

Next, processing logic opens the custom data schema (processing block 406) and locates the tags relating to the custom data type of interest (processing block 408).

Further, processing logic adds the custom data elements to the located tags (processing block 410) and closes the custom data schema with the newly defined data elements (processing block 412).

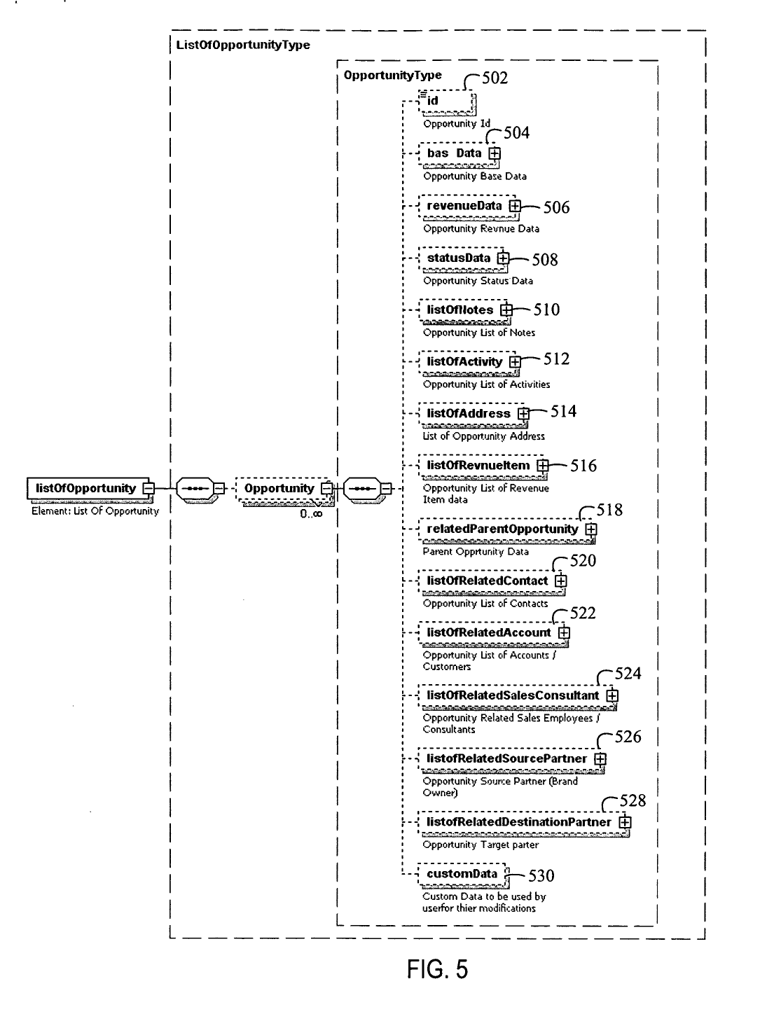

One embodiment of a common data model representing an opportunity will now be described in more detail in conjunction with FIGS. 5-16. One skilled in the art will appreciate that various other common data models representing opportunity can be used with the present invention without loss of generality. In addition, the names of data elements illustrated in FIGS. 5-16 are descriptive of the information stored in the data elements.

FIG. 5 illustrates the highest level data elements of the opportunity class in one embodiment. The highest level data elements include id 502, baseData 504, revenueData 506, statusData 508, listOfNotes 510, listOfActivity 512, listOfAddress 514, listOfRevenueItem 516, realtedParentOpportunity 518, listOfRelatedContact 520, listOfRealtedAccount 522, listOfRelatedSalesConsultant 524, listOfRelatedSourcePartner 526, listOfRelatedDestinationPartner 528, and customData 530.

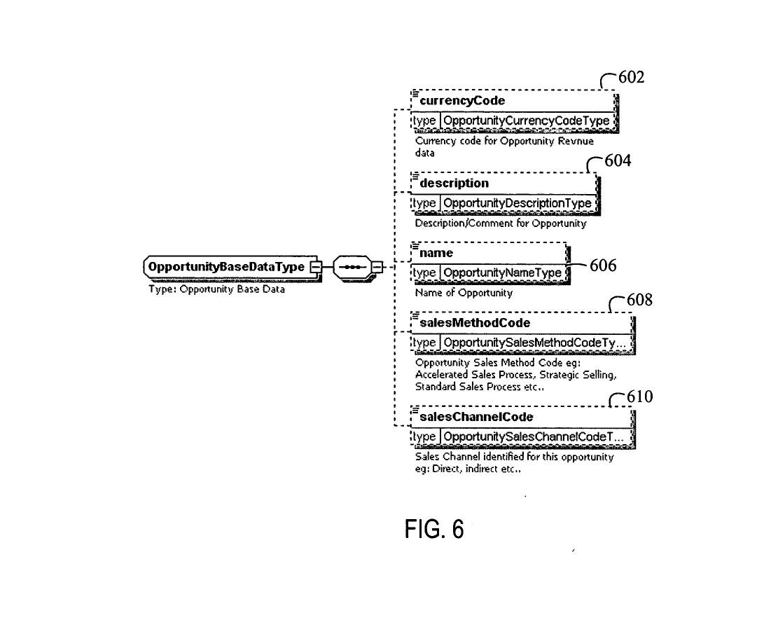

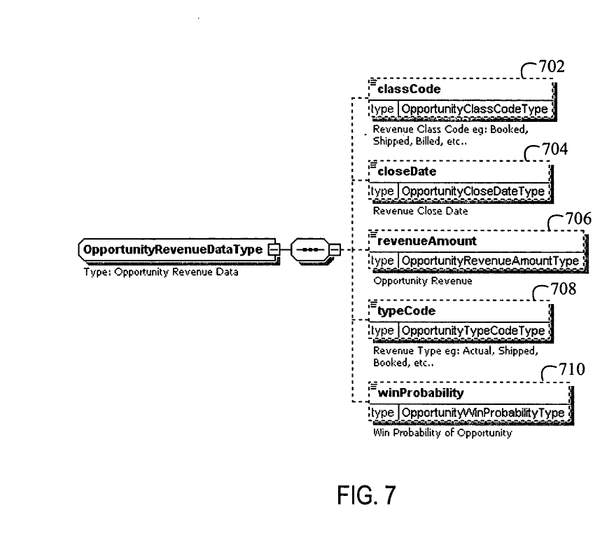

The id data element 502 may be a unique identifier of an opportunity. The baseData data element 504 contains general information about the opportunity, as will be discussed in more detail below in conjunction with FIG. 6. The revenueData data element 506 contains information on revenue information associated with the opportunity, as will be discussed in more detail below in conjunction with FIG. 7.

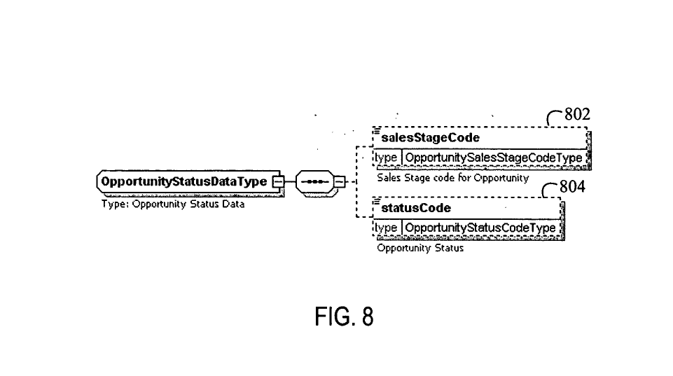

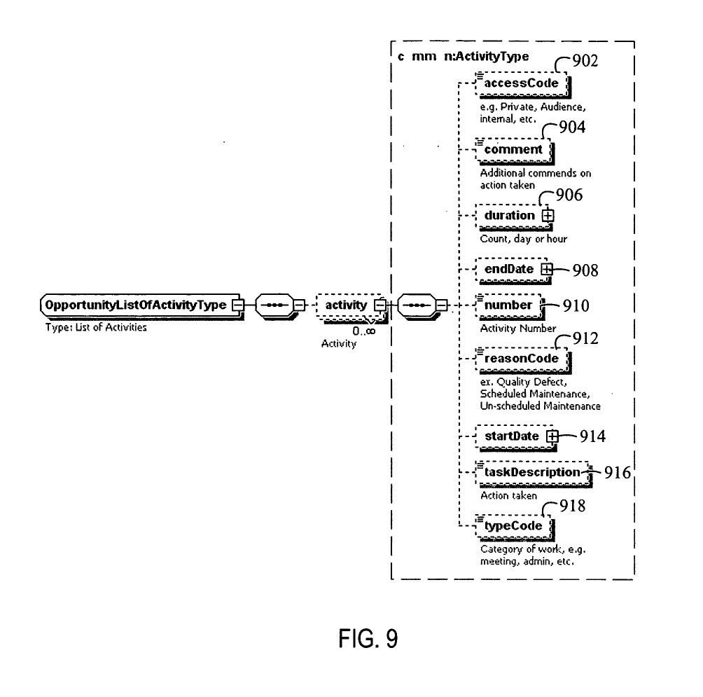

The statusData data element 508 contains information on the status of the opportunity, as will be discussed in more detail below in conjunction with FIG. 8. The listOfNotes data element 510 contains notes associated with the opportunity. The listOfActivity data element 512 contains information about the activities associated with the opportunity, as will be discussed in more detail below in conjunction with FIG. 9. The listOfAddress data element 514 contains information on the addresses associated with the opportunity.

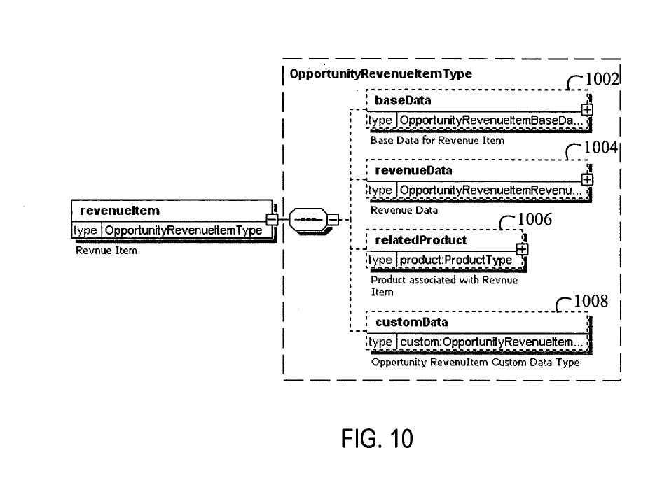

The listOfRevenueItem data element 516 contains information on revenue items associated with the opportunity, as will be discussed in more detail below in conjunction with FIG. 10. The relatedParentOpportunity data element 518 contains information on a parent opportunity (if it exists) that triggered the current opportunity

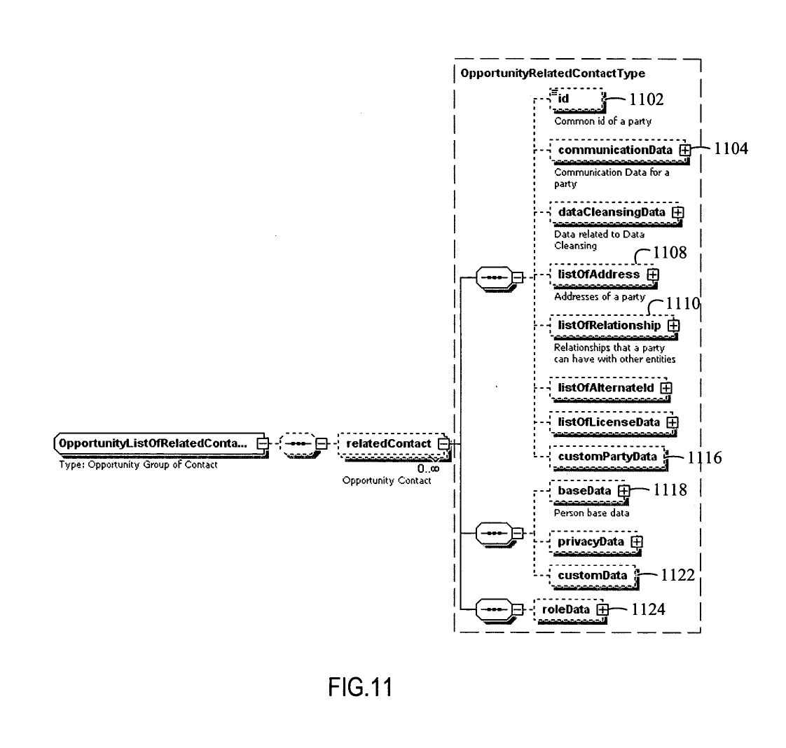

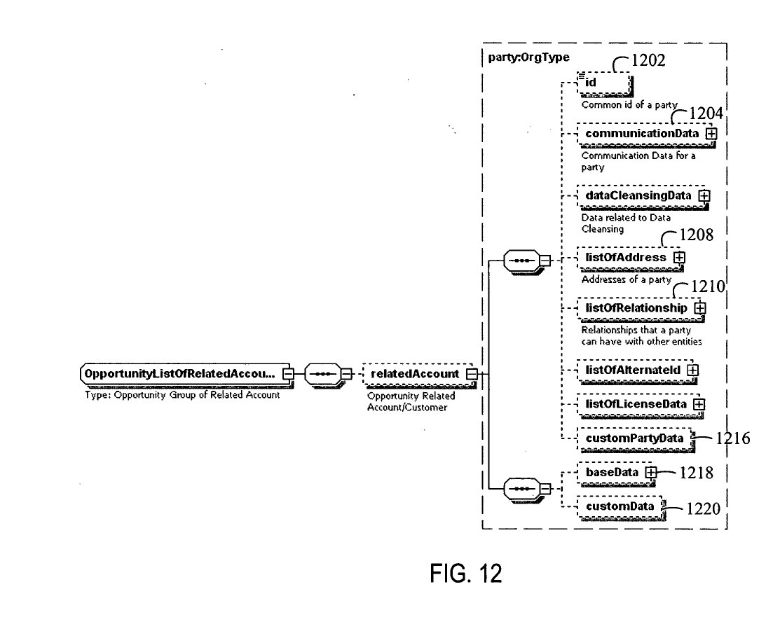

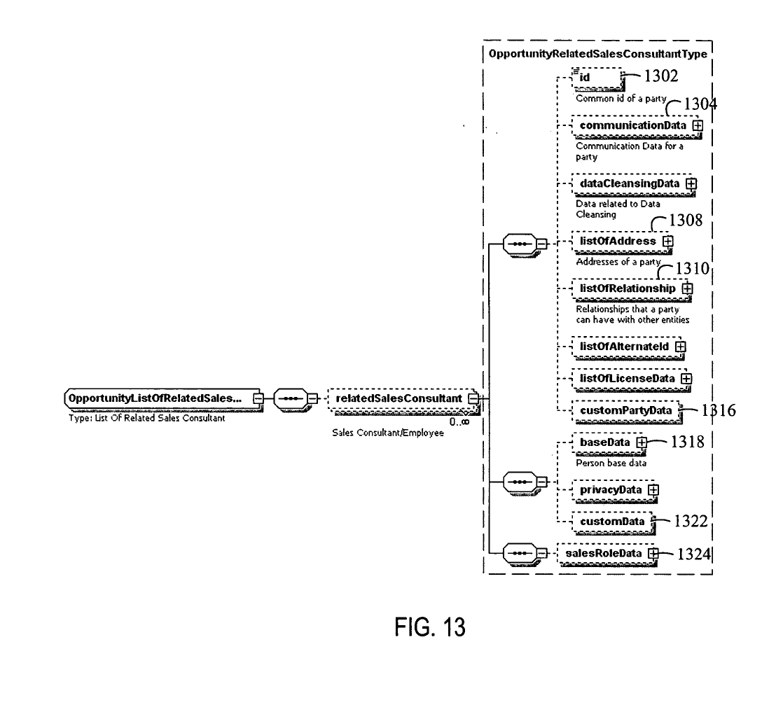

The listOfRelatedContact data element 520 contains information on contacts associated with the opportunity, as will be discussed in more detail below in conjunction with FIG. 11. The listOfRealtedAccount data element 522 contains information on customers associated with the opportunity, as will be discussed in more detail below in conjunction with FIG. 12. The listOfRelatedSalesConsultant data element 524 contains information on sales employees and consultants associated with the opportunity, as will be discussed in more detail below in conjunction with FIG. 13. The listOfRelatedSourcePartner data element 526 contains information on a source organization such as a brand owner. The listOfRelatedDestinationPartner data element 528 contains information on an opportunity target partner such as a reseller. The customData data element 530 initially contains no data elements, but custom data elements can be added by defining data elements in the OpportunityCustomDataType.

FIG. 6 illustrates the base data elements of the baseData class in one embodiment. The data elements of the baseDataType class include currencyCode 602, description 604, name 606, salesMethodCode 608, and salesChannelCode 610.

The currencyCode data element 602 specifies an opportunity uniform currency code. The description data element 604 contains information on the description and comments for the opportunity. The name data element 606 identifies the name of opportunity. The salesMethodCode data element 608 contains information on a user defined sales method (e.g., accelerated sales process, strategic selling, standard sales process, etc.). The salesChannelCode data element 610 contains information on sales channels identified for this opportunity (e.g., direct channels, indirect channels, etc.).

FIG. 7 illustrates the data elements of the OpportunityRevenueData class in one embodiment. The data elements include classCode 702, closeDate 704, revenueAmount 708, typeCode 710 and winProbability 712.

The classCode data element 702 contains information on the source of revenue (e.g., pipeline, upside, expected, committed, closed, etc.). The closeDate data element 704 contains information on the expected revenue close date. The revenueAmount data element 706 contains information on realized revenue. The typeCode data element 708 contains information on the revenue type (e.g., actual, shipped, billed, booked, projected, quota, etc.). The winProbability data element 710 contains information on the probability of accomplishing this opportunity.

FIG. 8 illustrates the data elements of the OpportunityStatusData class in one embodiment. The data elements include salesStageCode 802 and statusCode 804.

The salesStageCode data element 802 identifies the current sales stage that the opportunity is in. The statusCode data element 804 identifies the status of the opportunity.

FIG. 9 illustrates the data elements of the OpportunityListOfActivity class in one embodiment. These data elements include the accessCode 902, the comment 904, the duration 906, the endDate 908, the number 910, the reasonCode 912, the startDate 914, the taskDescription 916, and the typecode 918.

The accessCode data element 902 identifies the type of access to the opportunity information (e.g., private, audience, internal, etc.). The comment data element 904 contains additional comments on the action taken. The duration data element 906 contains information on the activity duration. The number data element 910 contains information on the activity number. The endDate data element 908 identifies the end of the activity. The reasonCode data element 912 identifies the reason for the activity (e.g., quality defects, scheduled maintenance, etc.). The startDate data element 914 identifies the beginning of the activity. The taskDescription data element 916 contains information on the action taken. The typeCode data element 918 contains information on a category of work involved (e.g., a meeting, an administrative procedure, etc.).

FIG. 10 illustrates the data elements of the revenueItem class in one embodiment. These data elements include baseData 1002, revenueData 1004, relatedProduct 1006, and customData 1008.

The baseData data element 1002 contains general information on the revenue items. The revenueData data element 1004 contains details on the projected revenue items. The relatedProduct data element 1006 contains information on products associated with the revenue items.

FIG. 11 illustrates the data elements of the RelatedContact class in one embodiment. The data elements used in the RealtedContact class include id 1102, communicationData 1104, listOfAddress 1108, listOfRelationship 1110, customPartyData 1116, baseData 1118, customData 1120 and roleData 1122.

The id data element 1102 contains a unique identifier of a contact party. The communicationData data element 1104 contains communication information for the contact party. The listOfAddress data element 1108 contains information on the addresses of the contact party. The listOfRelationship data element 1110 contains information on the relationships that the contact party can have with other entities. The baseData data element 1118 contains general information about the contact party. The roleData data element 1124 identifies the role of the contact party with respect to the current opportunity.

FIG. 12 illustrates the data elements of the RelatedAccount class in one embodiment. The data elements used in the RelatedAccount class include id 1202, communicationData 1204, listOfAddress 1208, listOfRelationship 1210, customPartyData 1216, baseData 1218, and custom Data 1220.

The id data element 1202 contains a unique identifier of a customer. The communicationData data element 1204 contains communication information for the customer. The listOfAddress data element 1208 contains information on the addresses of the customer. The listOfRelationship data element 1210 contains information on the relationships that the customer can have with other entities. The baseData data element 1218 contains general information about the customer.

FIG. 13 illustrates the data elements of the RelatedSalesConsultant class for one embodiment. The data elements used in the RelatedSalesConsultant class include id 1302, communicationData 1304, listOfAddress 1308, listOfRelationship 1310, customPartyData 1316, baseData 1318, customData 1322, and salesRoleData 1324.

The id data element 1302 contains a unique identifier of a sales consultant or employee. The communicationData data element 1304 contains communication information for the sales consultant or employee. The listOfAddress data element 1308 contains information on the addresses of the sales consultant or employee. The listOfRelationship data element 1310 contains information on the relationships that the sales consultant or employee can have with other entities. The baseData data element 1318 contains general information about the sales consultant or employee. The salesRoleData data element 1324 identifies the role of the sales consultant or employee with respect to the current opportunity.

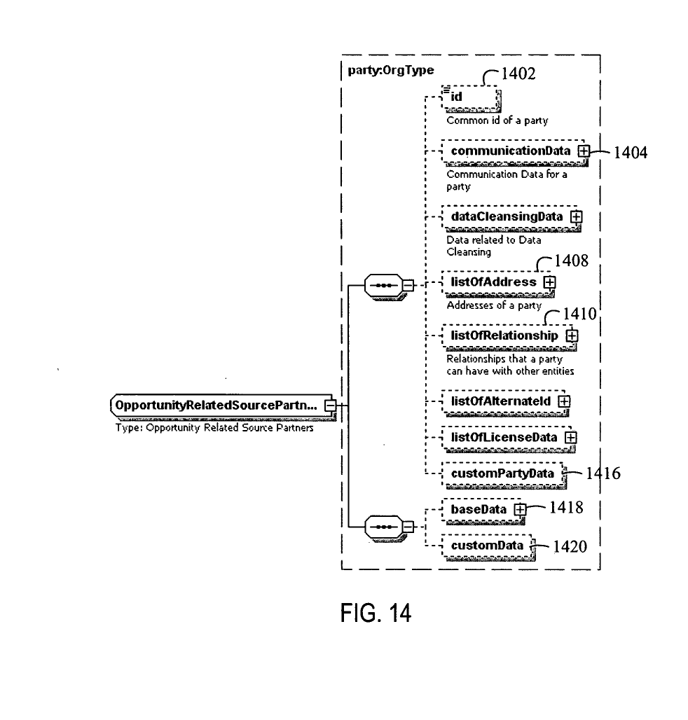

FIG. 14 illustrates the data elements of the RelatedSourcePartner class in one embodiment. These data elements include id 1402, communicationData 1404, dataCleansingData 1406, listOfAddress 1408, listOfRelationship 1410, listOfAlternateID 1412, listOfLicenseData 1414, customPartyData 1416, baseData 1418 and customData 1420.

The id data element 1402 contains a unique identifier of a source partner. The communicationData data element 1404 contains communication information for the source partner. The listOfAddress data element 1408 contains information on the addresses of the source partner. The listOfRelationship data element 1410 contains information on the relationships that the source partner can have with other entities. The baseData data element 1418 contains general information about the source partner.

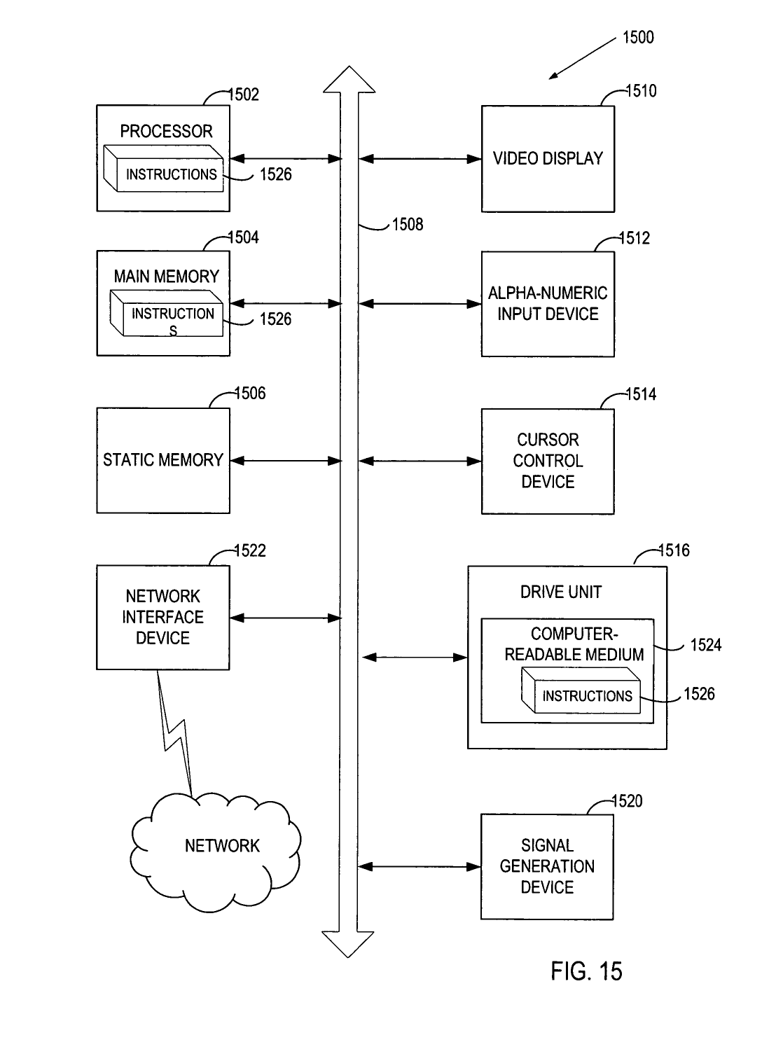

FIG. 15 is a block diagram of an exemplary computer system 1500 (e.g., of the integration server 200 of FIG. 2) that may be used to perform one or more of the operations described herein. In alternative embodiments, the machine may comprise a network router, a network switch, a network bridge, Personal Digital Assistant (PDA), a cellular telephone, a web appliance or any machine capable of executing a sequence of instructions that specify actions to be taken by that machine.

The computer system 1500 includes a processor 1502, a main memory 1504 and a static memory 1506, which communicate with each other via a bus 1508. The computer system 1500 may further include a video display unit 1510 (e.g., a liquid crystal display (LCD) or a cathode ray tube (CRT)). The computer system 1500 also includes an alpha-numeric input device 1512 (e.g., a keyboard), a cursor control device 1514 (e.g., a mouse), a disk drive unit 1516, a signal generation device 1520 (e.g., a speaker) and a network interface device 1522.

The disk drive unit 1516 includes a computer-readable medium 1524 on which is stored a set of instructions (i.e., software) 1526 embodying any one, or all, of the methodologies described above. The software 1526 is also shown to reside, completely or at least partially, within the main memory 1504 and/or within the processor 1502. The software 1526 may further be transmitted or received via the network interface device 1522. For the purposes of this specification, the term “computer-readable medium” shall be taken to include any medium that is capable of storing or encoding a sequence of instructions for execution by the computer and that cause the computer to perform any one of the methodologies of the present invention. The term “computer-readable medium” shall accordingly be taken to included, but not be limited to, solid-state memories, optical and magnetic disks, and carrier wave signals.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

What is claimed is:

1. A method in a computer system for representing a class definition, the method comprising:
defining an opportunity class representing an opportunity, the opportunity class identifying a set of relationships of the opportunity with a plurality of entities related to the opportunity.

2. The method of claim 1 wherein the plurality of entities related to the opportunity includes entities selected from the group consisting of related accounts, related contact parties, one or more related parent opportunities, related sales employees and consultants, activities associated with the opportunity, a related source organization, a related destination partner, and related revenue.

3. The method of claim 1 wherein the opportunity class includes a custom data element for defining one or more custom data fields for the opportunity class.

4. The method of claim 3 wherein the one or more custom data fields of the opportunity class are specific to an application.

5. The method of claim 1 further comprising:
instantiating the opportunity class; and
initializing data elements of the instantiated opportunity class.

6. The method of claim 5 further comprising:
transforming data received from a source application into a common format of the opportunity class;
transforming the data from the common format into a target format of a target application; and
sending the data in the target format to the target application.

7. The method of claim 1 wherein a definition of the opportunity class is represented as an XML schema.

8. A method for data transformation, the method comprising:
receiving opportunity data from a source application; and
transforming the opportunity data into a common format provided by an opportunity class,
wherein the opportunity class identifies a set of relationships of an opportunity with a plurality of entities related to the opportunity.

9. The method of claim 8 wherein the plurality of entities related to the opportunity includes entities selected from the group consisting of related accounts, related contact parties, one or more related parent opportunities, related sales employees and consultants, activities associated with the opportunity, a related source organization, a related destination partner, and related revenue.

10. The method of claim 8 wherein the opportunity class includes a custom data element for defining one or more custom data fields for the opportunity class.

11. A machine-readable medium having executable instructions to cause a machine to perform a method comprising:
defining an opportunity class representing an opportunity, the opportunity class identifying a set of relationships of the opportunity with a plurality of entities related to the opportunity.

12. The machine-readable medium of claim 11 wherein the plurality of entities related to the opportunity includes entities selected from the group consisting of related accounts, related contact parties, one or more related parent opportunities, related sales employees and consultants, activities associated with the opportunity, a related source organization, a related destination partner, and related revenue.

13. The machine-readable medium of claim 11 wherein the opportunity class includes a custom data element for defining one or more custom data fields for the opportunity class.

14. The machine-readable medium of claim 13 wherein a definition of the opportunity class is represented as an XML schema.

15. A machine-readable medium having executable instructions to cause a machine to perform a method comprising:
receiving opportunity data from a source application; and
transforming the opportunity data into a common format provided by an opportunity class,
wherein the opportunity class represents an opportunity and identifies a set of relationships of the opportunity with a plurality of entities related to the opportunity.

16. The machine-readable medium of claim 15 wherein the plurality of entities related to the opportunity includes entities selected from the group consisting of related accounts, related contact parties, one or more related parent opportunities, related sales employees and consultants, activities associated with the opportunity, a related source organization, a related destination partner, and related revenue.

17. The machine-readable medium of claim 15 wherein the opportunity class includes a custom data element for defining one or more custom data fields for the opportunity class.

18. A system comprising:
a memory; and
at least on processor coupled to the memory, the processor executing a set of instructions which cause the processor to define an opportunity class representing an opportunity, the opportunity class identifying a set of relationships of the opportunity with a plurality of entities related to the opportunity.

19. The system of claim 18 wherein the plurality of entities related to the opportunity includes entities selected from the group consisting of related accounts, related contact parties, one or more related parent opportunities, related sales employees and consultants, activities associated with the opportunity, a related source organization, a related destination partner, and related revenue.

20. A system comprising:
a memory; and
at least on processor coupled to the memory, the processor executing a set of instructions which cause the processor to
receive opportunity data from a source application, and
transform the opportunity data into a common format provided by an opportunity class,
wherein the opportunity class represents an opportunity and identifies a set of relationships of the opportunity with a plurality of entities related to the opportunity.

21. The system of claim 20 wherein the plurality of entities related to the opportunity includes entities selected from the group consisting of related accounts, related contact parties, one or more related parent opportunities, related sales employees and consultants, activities associated with the opportunity, a related source organization, a related destination partner, and related revenue.

22. An apparatus for representing a class definition, the apparatus comprising:
means for defining an opportunity class representing an opportunity of different types, the opportunity class identifying a set of relationships of the opportunity with a plurality of entities related to the opportunity.

23. An apparatus for data transformation, the apparatus comprising:
means for receiving opportunity data from a source application; and
means for transforming the opportunity data into a common format provided by an opportunity class,
wherein the opportunity class represents the opportunity and identifies a set of relationships of the opportunity with a plurality of entities related to the opportunity.
